(19) United States
(12) Patent Application Publication
(10) Pub. No.: US 2017/0061543 A1
(43) Pub. Date: Mar. 2, 2017

(54) USER INTERFACE FOR LIFE INSURANCE VALUATION

(71) Applicant: Value App, LLC, Seattle, WA (US)

(72) Inventors: G. Chris Kosmos, Seattle, WA (US); Amy Bautista, Seattle, WA (US)

(21) Appl. No.: 14/836,336

(22) Filed: Aug. 26, 2015

(51) Int. Cl. G06Q 40/08

(52) U.S. Cl. CPC G06Q 40/08

(57) ABSTRACT

Computer systems and related methods provide individuals with near-instantaneous, realistically valued quotes for life insurance policies at their convenience. The life insurance values are computed without medical or in-depth policy information about the insured.

### BACKGROUND

Life insurance is a contract between an insured and an insurer, where the insurer promises to pay a designated beneficiary of the insured, upon the death of the insured person, a sum of money, often called the “death benefit,” in exchange for a premium paid to the insurer. Cash-value life insurance, such as whole life and universal life, builds reserves through excess premiums plus earnings. Cash-value life insurance offers the opportunity to access cash accumulations within the policy either through withdrawals, policy loans, or partial or full surrender of the policy. Another alternative involves selling the policy for cash, a procedure known as a life settlement. The purchase value of a life insurance policy typically is computed based on the insured's life expectancy, which is based on the insured's medical records.

### SUMMARY

In one general aspect, the present invention is directed to computer systems and related methods that provide individuals with near-instantaneous, real policy values for life insurance policies at their convenience. The life insurance values are computed with no medical information about the insured. This avoids the technological problem of having to perform medical screening tests on the individuals to obtain the quote and having to upload the results to the calculator. The quote is also calculated without in-depth review of the policy characteristic, which avoids the technological problem of having to input complicated data into models to calculate the value. These and other benefits of the present invention will be apparent from the description that follows.

### FIGURES

Various embodiments of the present invention are described herein by way of example in connection with the following figures, wherein:

FIG. 1 is a block diagram of a computer system according to various embodiments of the present invention;

FIGS. 2, 4 and 5 are example web page screen shots according to various embodiments of the present invention; and

FIG. 3 is a flow chart of a process flow executed by the back-end computer system of the computer system of FIG. 1 according to various embodiments of the present invention.

### DESCRIPTION

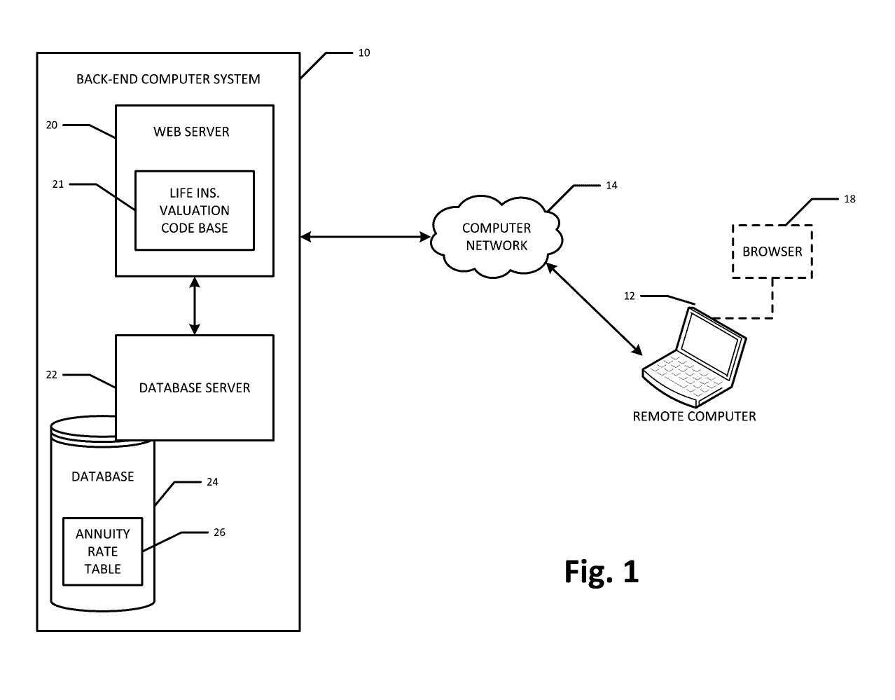

In one general aspect, the present invention is directed to a computer architecture and related methods through which a user can receive value quotes for a life insurance policy of an insured (which may or may not be the remote user, such as if the remote user is acting on behalf of the insured). The life insurance policy may be a universal life, variable universal life, whole, or term life insurance policy, for example. FIG. 1 is a diagram of the computer architecture according to various embodiments of the present invention. The computer architecture comprises a back-end computer system 10 and a remote computer device 12. The remote computer device 12 is in communication with the back-end computer system 10 via a computer network 14, such as the Internet or other suitable type of TCP/IP network through which the back-end computer system 10 can serve web pages to the remote computer device 12. As shown in FIG. 1, the back-end computer system 10 can comprises a web server 20 and a database server 22. The web server 20 generates and serves web pages, via the network 14, that the remote computer device 12 can render and display with a web browser or other suitable software application 18. The web server 20 can be, for example, a Microsoft Internet Information Services (IIS) server, and the web server 20 may also comprise a life insurance valuation code base 21 comprising software that, when executed by a processor of the web server 20, causes the web server 20 to compute the life insurance values, as described below. The database server 22 can store data in and retrieve data from a database 24. The database server 22 may be, for example, a Microsoft SQL server. In particular, the database 24 may store data that are needed to compute the values of the life insurance policies, such as an annuity rate table 26, whose utility in computing the life insurance policy values is described further below. Also, the remote computer device 12 may be any type of network-enabled computer device that is capable of accessing the back-end computer system 10 via the network 14 and displaying the content of the web pages generated and served by the web server 20, such as a personal computer, a laptop, a tablet computer, a smartphone, etc. Only one remote computer device 12 is shown in FIG. 1, although numerous, separate remote computer devices 12 could connect to the back-end computer system 10 via the network 14.

The back-end computer system 10 may generate and serve web pages that allow a user at the remote computer device 12 to enter limited personal details about the insured in order to receive a quote on the value of a life insurance policy covering the insured. The back-end server 10 can generate a dynamic web page that first prompts the user for relevant, limited information about the insured to price the policy; then computes the value of the policy based on the inputs received from the remote user; and then updates the web page with the computed value (or a range that is based on the computed value) so that when the web pages is reloaded by the remote computer device 12 the value (or value range as the case may be) is displayed on the web page for the remote user.

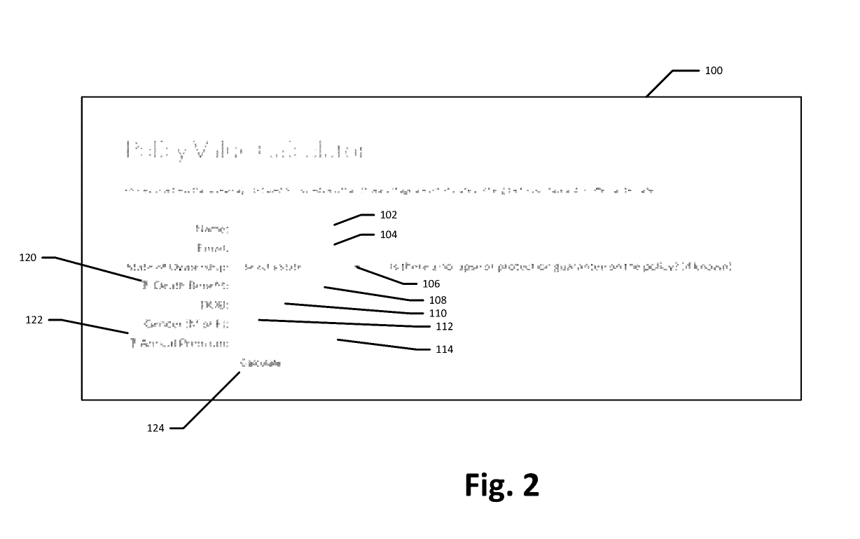

FIG. 2 is an example screen shot of a web page 100 that the back-end computer system 10 can serve to the remote computer device 12 to receive the inputs about the life insurance policy to be valued. As shown in the example of FIG. 2, the web page 100 can include a field 102 where the remote user inputs the name of the insured; a field 104 where the remote user inputs an email address for the user/insured; a field 106 where the remote user selects (such as from a drop down menu) the state in which the insured lives; a field 108 where the user inputs the death benefit amount of the policy; a field 110 where the user inputs the date of birth (DOB) of the insured; a field 112 where the user inputs the gender of the insured; and a field 114 where the user inputs the annual premium amount of the insured's policy. The insured's state of residence may be relevant because the provider of the quotes (e.g., the “calculator” or business administering the computer system 10) may not be approved to issue such quotes in certain states. Also as shown in FIG. 2, the web page 100 may have informational icons 120, 122 that the user can click on or otherwise activate to be presented more information about the requested details. For example, by clicking on or otherwise activating the icon 120, a second browser window (e.g., a pop-up window) can open on the remote computer device 12 that explains what the death benefit is and/or where the user could find it specified in a typical life insurance policy. Similarly, by clicking on or otherwise activating the icon 122, another browser window (e.g., a pop-up window) could open on the remote computer device 12 that explains what the annual premium is and/or where the user could find it specified in a typical life insurance policy.

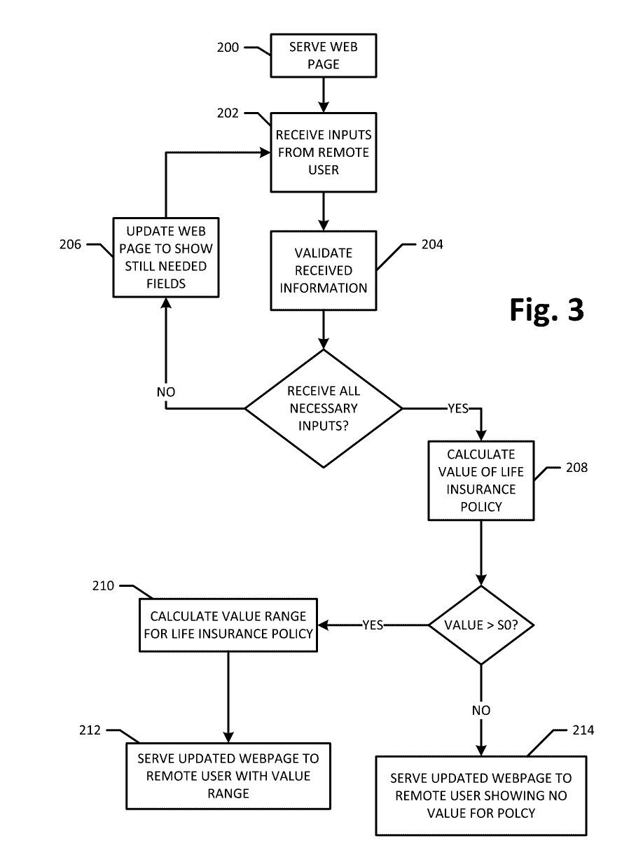

Once the remote user completes the required fields 110-114, the user can click or otherwise activate the “Calculate” button 124 to obtain the value range for the insurance policy. FIG. 3 is a flow chart of an exemplary process flow implemented by the back-end computer system 10 to determine the value range of the life insurance policy. At step 200, when the remote user navigates to the appropriate web page to request a valuation of their life insurance policy, the back-end server 10 (e.g., the web server 20) serves the web page 100 (see FIG. 2) to the remote computer 12. When the remote user activates the “Calculate” (or similar) button 124, at step 202, the web server 20 receives the inputs that the remote user entered in the fields 102-114, such as through HTTP requests to the web server 20.

At step 204, the back-end computer system 10, and in particular the web server 20, validates the received data. For example, the web server 20 can make sure that all of the necessary fields 102-114 are completed with valid data. Additionally, even when inputs are provided for a particular field, the web server 20 can determine whether the inputs are valid. For example, the web server 20 can determine whether a valid email address is entered in the e-mail field 104 based on its address format (e.g., whether it has “@” followed by a suitable administrative domain); it can determine whether the death benefit entered in the death benefit field 108 is in an acceptable range (e.g., $200,000 to $15,000,000); it can determine whether the DOB is acceptable (e.g., the insured is between 10 and 120 years of age); and it can determine whether the annual premium entered into the annual premium field 114 is in an acceptable, predetermined dollar figure range. If the input data fall outside any of the expected ranges, or if a particular field(s) is not filled in by the remote user, the web server 20 at step 206 can serve an updated version of the web page 100 back to the remote user indicating the fields that the user needs to correct and/or fill in.

Once valid entries for the requisite fields are received, at step 208 the web server 20 (executing the life insurance valuation code base 21) computes a value for the life insurance policy. Importantly, the back-end computer system 10 does not use medical information about the insured to compute the life insurance value. As such, the web server 20 computes the value for the life insurance without knowing medical information about the insured that is typically used in valuing a life insurance policy, such as:
Height and weight
Smoking and alcoholic consumption habits
Blood pressure
Heart rate
Cholesterol levels
Past surgeries and diagnoses
Blood, urine and other test results
Family medical history
   Furthermore, the back-end computer system 10 does not use in-depth policy information, such as annual cost of insurance and shadow accounts. Instead, the web server 20 only uses the data input by the remote user (e.g., fields 102-114, see FIG. 2) and data stored in the database 24 of the database server 22 (see FIG. 1) to compute the life insurance value. That way, as described below, the user/insured can obtain a realistic, approximate value of their life insurance policy without medical records and without having a team of specialists run technical actuarial calculations and other various analyses. For purposes of this patent, state of residence and age/date-of-birth (DOB) are not considered medial records or information (note that age and DOB are used interchangeably herein unless otherwise noted since DOB can be directly translated into current age).

Preferably, the web server 20 computes the value of the life insurance according to the following formula:

$$Value = DeathBenefit - \frac{\begin{matrix}( HurdleRate \times DeathBenefit ) + \\ AnnualPolicyPremium\end{matrix}}{AnnuityRate} \qquad [ Formula 1 ]$$

In this formula, “DeathBenefit” represents the death benefit amount of the policy input by the user at field 108 (see FIG. 2); “HurdleRate” is a positive number less than 1.0 that represents an internal, predetermined target return rate (e.g., 5% to 8%, or 0.05 to 0.08) if the life insurance policy was acquired; “AnnualPolicyPremium” represents the policy's annual premium input by the user at field 114 (see FIG. 2); and “AnnuityRate” is an applicable rate of return for a fixed, single premium immediate annuity (SPIA) for the insured if one were obtained for the insured at the time of the calculation, where the rate is based on at least the insured's age and gender. In that connection, the database 24 may include a table 26 of applicable annuity rates for individuals by age and gender. An administrator of the back-end computer system 10 can periodically update the annuity rate table 26 based on current market rates from annuity carriers. The Annuity Rate is typically between 7% and 18% (e.g., 0.07 and 0.18). All rates in Formula 1 above are expressed as decimal numbers (as opposed to percentages) and the Death Benefit and Annual Policy Premium should be in the same currency (e.g., USD), such that the result, “Value,” will be in that currency. If the result of the computation is negative, e.g., if

$$\frac{( HurdleRate \times DeathBenefit ) + AnnualPolicyPremium}{AnnuityRate} > DeathBenefit$$

then the value of the life insurance policy can be set to zero.

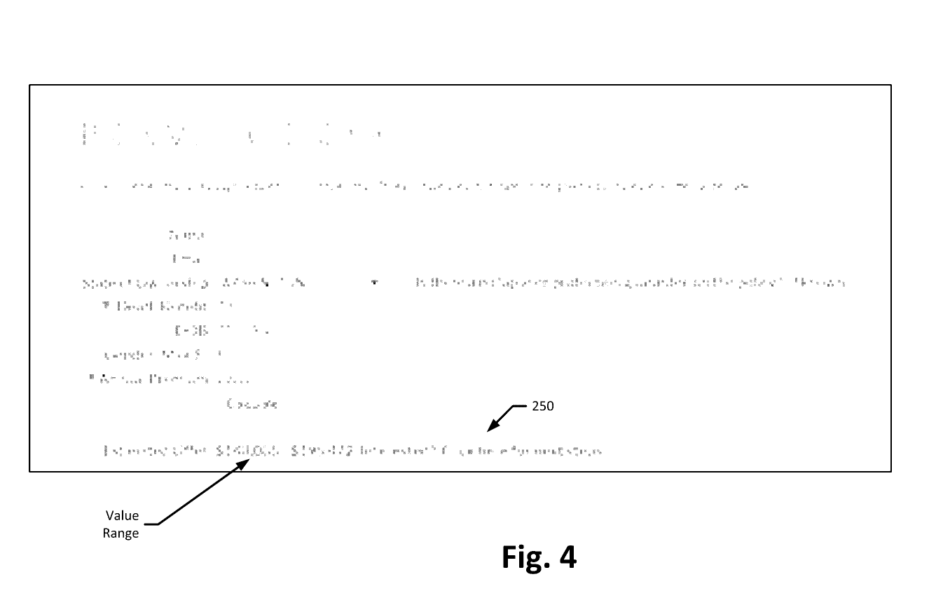

Returning to FIG. 3, once the value of the life insurance policy is determined at step 208, if the value is greater than zero (or some other nominal amount), at step 210 the back-end computer system 10 computes a value range for the life insurance policy. In various embodiments, the value range can be some fraction (e.g., 75.0%) of the computed value up to the computed value. For example, if the computed value of the life insurance policy determined at step 208 is $195,472, the value could be $148,085 to $195,472 (75.75% was used for the range in this example). Of course, in other embodiments, different thresholds and/or different ways for computing the range can be used. Then, at step 212, the web server 20 can change the web page so that it is reloaded by the remote computer device 12 to display the computed value range as shown in the example of FIG. 4. If the value of the life insurance policy is not greater than the threshold amount (e.g., $0), at step 214 the web server 20 can update the web page upon reload that the life insurance policy has no value.

The database 24 (or some other database of the back-end computer system 10) can also store, for each user, the data that the user inputs (see FIG. 2) as well as the computed life insurance value and/or value range. The database 24 could store a table(s) with rows associated with the users. Each user could be assigned a unique ID based on their name and/or email address for purposes of the data table. The other columns in the rows can indicate the data that the users input and the life insurance value and/or value range that was computed and provided to the user. The table can also include timestamps for the computations so that if a user obtains multiple quotes at different times, it is discernable what quote the user received at the various times.

The web page 100 described above can be a dynamic web page. As such, the web server 20 may include server-side scripting that changes the web page, or just a portion of it, for example, when the value range is computed in response to the user clicking or otherwise activating the “Calculate” button 124, and sends a message to the remote computer device 12 to reload the web page to show the computed value range. The web page 100 is preferably written in HTML or a comparable markup language. The web browser 24 of the remote computer device 12 may use HTTP to request the web page 100 and updates thereto. The dynamic web pages 100 can be created with server-side languages such as ASP, ColdFusion, JavaScript, Perl, PHP, Ruby, or WebDNA, for example. The web server 100 may also use a Common Gateway Interface (CGI) to produce the dynamic web pages. The web server 20 (and the web pages) can also use Ajax programming to interchange information between the web server 20 and the remote computer 12. For example, a javascript file may reload the web page (or portions of it) at fixed intervals. Using Ajax, the web page HTML file can contain a place holder for the computed value range, which is updated in another file when computed. The portion of the web page that shows the computed value range can then be reloaded once it is computed so that it is displayed in the web page.

In other embodiments, instead of using dynamic web pages, the web server 20 can generate and serve separate static web pages, such as one for requesting the necessary information to make the valuation (e.g., FIG. 2) and a second web page that displays the computed range (e.g., FIG. 4). The second web page may be generated in response to the remote user activating the “Calculate” button 124 in FIG. 2 and served to the remote user 12 via the network 14 (see FIG. 1).

Also, in the above-description it was assumed that the remote computer device 12 employed a browser 18 to render and display the web pages from the web server 20. In other embodiments, the remote computer device 12 may have a self-contained software program for displaying the webpages from the web server 20. For example, the remote computer device 12 could be a smartphone, tablet or laptop computer that has a dedicated life insurance evaluation app (e.g., a mobile app) that renders and displays the HTML pages from the web server 20. The app may utilize a browser bundled inside of the app, such as WebView, so that the app can use Web technologies (such as HTML, JavaScript, CSS, etc.) but still be packaged as a native app. The app could be pre-installed on the device 12 or the remote user could download the app from any suitable app store.

The web server 20 and the database server 22 may comprise suitable and appropriate processor(s) and memory. For example, the web server 20 and the database server 22 may comprise primary (or main) memory (e.g., RAM and ROM) and secondary (or auxiliary) memory (e.g., HDDs, SSDs, RAID, etc.) The code base 21 of the web server 20 may be stored in ROM and/or secondary memory, and loaded into RAM of the web server 20 when executed by the processor(s) of the web server 20. The annuity rate table 26 of the database server 22 may be stored in secondary memory, for example. The database server 22 may retrieve the appropriate annuity rate from the table 26 for the web server 22 upon request to compute the life insurance values.

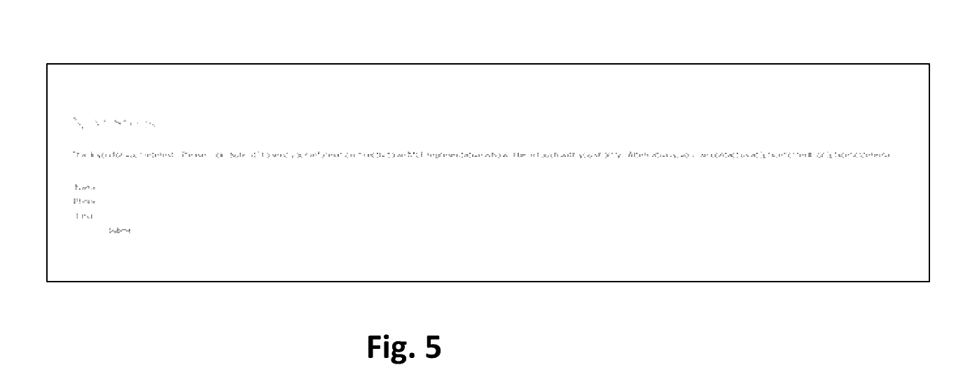

As shown in the example of FIG. 4, the web page can also include a hyperlink 250, preferably next to or near the stated value range, that links (when activated) the user to a new web page if the user is interested in selling the life insurance policy. An example of such a web page is shown in FIG. 5. On this web page, the user can enter contact information for a representative associated with the back-end computer system 10 to contact the user about purchasing the life insurance policy. Insureds that receive a low estimated value (e.g., $0) will be discouraged from proceeding further to settlement (i.e., selling their policy), which in turn saves the potential purchaser of the policies (e.g., the administrator of the back-end computer system 10) the time and expense of evaluating such policies that are unlikely to be sold. That way, the resources of the potential purchaser can be allocated to the policies where the insureds are amenable to settlement given the acceptably high computed value range.

In other variations, the hyperlink 250 (see FIG. 4) can take the user to a web page(s) where the user uploads their illustration and fills out an on-line application to sell their policy. Based on the information provided, the back-end computer system 10 can then automate the processing of purchasing the policy. For example, based on the information provided, the back-end computer system 10 or a subject matter expert associated with it can determine the precise offer price for the policy. The back-end computer system can then provide the offer in a web page to the user. If the user accepts, the paperwork to effect the transaction can be prepared and provided to the user/insured.

The inventors have found that Formula 1 above yields an accurate estimate of the value of the life insurance policy since it uses an annuity rate that is based on the insured's age and gender. The computerized systems and methods described herein provide the estimated life insurance values to the user nearly instantaneous—at Internet speeds—at the convenience of the user (e.g., at the time and location of the user's choosing). It also obviates the need for expensive and time consuming medical screening of the insured, and obviates the cumbersome process of communicating the screening results to the calculator. In addition, the present invention eliminates the need for computer modeling of the insured's policy based on annual cost of insurance and shadow accounts, and without other actuarial analysis.

In one general aspect, therefore, the present invention is directed to a computer system that comprises a remote computer device 12 that comprises executable software 18 for displaying content on the remote computer device, and a back-end computer system 10 that is in communication with the remote computer device 12 via a computer network 14. The back-end computer system 10 comprises a web server 20 that comprises and executes a life insurance valuation code base 21, and a database server 22 that stores data for determining values of life insurance policies, including annuity rate data 26 for individuals based on age and gender. Upon executing the life insurance valuation code base, the web server 20 serves to the remote computer device 12 a dynamic webpage that is displayed by the software 18 of the remote computer device 12. The dynamic webpage comprises data input fields (see FIG. 1) soliciting information indicative of at least the following information from a user of the remote computer device who is seeking to value a life insurance policy for an insured individual; a death benefit amount of the life insurance policy of the insured individual; the gender of the insured individual; the current age of the insured individual; and an annual premium amount of the life insurance policy of the insured individual. Upon receiving a request from the remote computer device to calculate the value for the life insurance policy, the web server determines that the user input appropriate values in the data input fields and, upon a determination that the user input appropriate values in the data input fields, calculates a current estimated value for the life insurance policy based on the death benefit amount, the annual premium amount of the life insurance policy of the insured individual, an applicable hurdle rate, and an applicable annuity rate for the insured individual (stored in the database server and that is selected based on the gender and current age of the insured individual), and without using any other medical or policy information related to the insured individual to compute the current estimated value. When the calculated current estimated value is greater than a threshold amount, the web server then computes a value range for the life insurance policy that is based on the computed value and updates the dynamic webpage to show the computed value range when the dynamic web page is reloaded by the remote computer device.

In various implementations, the executable software for displaying content on the remote computer device comprises a browser or a mobile app. Also, the web server computes the current estimated value of the life insurance policy based on Formula 1 above. For example, computing the current estimated value of the life insurance policy can involve subtracting a first quantity from a second quantity, wherein the second quantity is proportional to the death benefit amount of the policy and first quantity includes a quotient whose denominator is proportional to the applicable annuity rate. The numerator of the quotient can comprise a sum of two summands: the first summand comprises a scaled amount of the death benefit (e.g., the hurdle rate times the death benefit) and the second summand comprises the annual policy premium.

In other various implementations, the back-end computer system comprises means for serving (e.g., the web server 20) to the remote computer device the dynamic webpage; means for calculating (e.g., the web server 20, including the life insurance valuation code base 21), in response to receiving a request from the remote computer device to calculate the value for the life insurance policy, a current estimated value for the life insurance policy and an associated value range for the life insurance policy; and means for updating the dynamic webpage (e.g., the web server) to show the computed value range when the dynamic web page is reloaded by the remote computer device.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. The Summary section may set forth one or more but not all exemplary embodiments as contemplated by the inventor(s), and thus, are not intended to limit the present invention and the appended claims in any way. The breadth and scope of the present invention should not be limited by any of the above-described exemplary embodiments, but should be defined only in accordance with the following claims and their equivalents.

What is claimed is:

1. A computer system comprising:
a remote computer device that comprises executable software for displaying content on the remote computer device;
a back-end computer system in communication with the remote computer device via a computer network, the back-end computer system comprising:
a web server that comprises and executes a life insurance valuation code base; and
a database server that stores data for determining values of life insurance policies, including annuity rate data for individuals based on age and gender,
wherein the web server, upon executing the life insurance valuation code base, is caused to:
serve to the remote computer device a dynamic webpage that is displayed by the software of the remote computer device, wherein the dynamic webpage comprises data input fields soliciting information indicative of at least the following information from a user of the remote computer device who is seeking to value a life insurance policy for an insured individual;
a death benefit amount of the life insurance policy of the insured individual;
the gender of the insured individual;
the current age of the insured individual; and
an annual premium amount of the life insurance policy of the insured individual; and
upon receiving a request from the remote computer device to calculate the value for the life insurance policy:
determine that the user input appropriate values in the data input fields;
upon a determination that the user input appropriate values in the data input fields, calculate a current estimated value for the life insurance policy based on the death benefit amount, the annual premium amount of the life insurance policy of the insured individual, an applicable hurdle rate, and an applicable annuity rate for the insured individual, stored in the database server, that is selected based on the gender and current age of the insured individual, and without using any other medical or policy information related to the insured individual to compute the current estimated value; and
when the calculated current estimated value is greater than a threshold amount, compute a value range for the life insurance policy that is based on the computed value; and
update the dynamic webpage to show the computed value range when the dynamic web page is reloaded by the remote computer device.

2. The system of claim 1, wherein the executable software for displaying content on the remote computer device comprises a browser.

3. The system of claim 1, wherein the executable software for displaying content on the remote computer device comprises a mobile app.

4. The system of claim 1, wherein the web server computes the current estimated value of the life insurance policy based on the formula:
$$Value = DeathBenefit - \frac{( α \times DeathBenefit ) + AnnualPolicyPremium}{AnnuityRate}$$
where Value is the computed current estimated value, DeathBenefit is the death benefit amount of the policy, α is the applicable hurdle rate, AnnualPolicyPremium is the policy's annual premium, and AnnuityRate is the applicable annuity rate.

5. The system of claim 1, wherein computing the current estimated value of the life insurance policy comprises subtracting a first quantity from a second quantity, and wherein the second quantity is proportional to the death benefit amount of the policy.

6. The system of claim 5, wherein the first quantity includes a quotient whose denominator is proportional to the applicable annuity rate.

7. The system of claim 6, wherein a numerator of the quotient comprises a sum of two summands, wherein the first summand comprises a product of the applicable hurdle rate and the death benefit, and the second summand comprises the annual policy premium.

8. A computer system comprising:
a remote computer device that comprises executable software for displaying content on the remote computer device;
a back-end computer system in communication with the remote computer device via a computer network, the back-end computer system comprising:
means for serving to the remote computer device a dynamic webpage that is displayed by the software of the remote computer device, wherein the dynamic webpage comprises data input fields soliciting information related to at least the following information from a user of the remote computer device who is seeking to value a life insurance policy for an insured individual;
a death benefit amount of the life insurance policy of the insured individual;
the gender of the insured individual;
the current age of the insured individual; and
an annual premium amount of the life insurance policy of the insured individual; and
means for calculating, in response to receiving a request from the remote computer device to calculate the value for the life insurance policy, a current estimated value for the life insurance policy and an associated value range for the life insurance policy, wherein the value range is based on the computed current estimated value, and wherein the current estimated value is computed based on:
the death benefit amount;
the annual premium amount of the life insurance policy of the insured individual;
an applicable hurdle rate; and
an applicable annuity rate for the insured individual that is based on the gender and current age of the insured individual, and without using any other medical or policy information related to the insured individual to compute the current estimated value; and
means for updating the dynamic webpage to show the computed value range when the dynamic web page is reloaded by the remote computer device.

9. A method comprising:
serving, by a back-end computer system to a remote computer device that is in communication with the remote computer device via a computer network, a dynamic webpage that is displayed by executable software of the remote computer device for displaying content on the remote computer device, wherein the dynamic webpage comprises data input fields soliciting information related to at least the following information from a user of the remote computer device who is seeking to value a life insurance policy for an insured individual;
a death benefit amount of the life insurance policy of the insured individual;
the gender of the insured individual;
the current age of the insured individual; and
an annual premium amount of the life insurance policy of the insured individual; and
calculating, by the back-end computer system, in response to receiving a request from the remote computer device to calculate the value for the life insurance policy, a current estimated value for the life insurance policy and an associated value range for the life insurance policy, wherein the value range is based on the computed current estimated value, and wherein the current estimated value is computed based on the death benefit amount, the annual premium amount of the life insurance policy of the insured individual, an applicable hurdle rate, and an applicable annuity rate for the insured individual that is based on the gender and current age of the insured individual, and without using any other medical or policy information related to the insured individual to compute the current estimated value; and
updating, by the back-end computer system, the dynamic webpage to show the computed value range when the dynamic web page is reloaded by the remote computer device.

10. The method of claim 9, wherein calculating the current estimated value of the life insurance policy comprises calculating the current estimated value of the life insurance policy based on the formula:
$$Value = DeathBenefit - \frac{( α \times DeathBenefit ) + AnnualPolicyPremium}{AnnuityRate}$$
where Value is the computed current estimated value, DeathBenefit is the death benefit amount of the policy, α is the applicable hurdle rate, AnnualPolicyPremium is the policy's annual premium, and AnnuityRate is the applicable annuity rate.

11. The method of claim 9, wherein computing the current estimated value of the life insurance policy comprises subtracting a first quantity from a second quantity, and wherein the second quantity is proportional to the death benefit amount of the policy.

12. The method of claim 11, wherein the first quantity includes a quotient whose denominator is proportional to the applicable annuity rate.

13. The method of claim 12, wherein a numerator of the quotient comprises a sum of two summands, wherein the first summand comprises a product of the applicable hurdle rate and the death benefit, and the second summand comprises the annual policy premium.
